(19) United States
(12) Patent Application Publication
(10) Pub. No.: US 2006/0246173 A1
(43) Pub. Date: Nov. 2, 2006

(54) Feed compositions and methods of making and using the same

(76) Inventor: Mewafak K. Raffo, El Cajon, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/118,905

(22) Filed: Apr. 28, 2005

(51) Int. Cl. A23K 1/18

(52) U.S. Cl. 426/2

(57) ABSTRACT

Disclosed herein are feed compositions, including avian feed compositions, as well as methods of making and using the compositions. Preferably, the compositions are made without animal components or animal derived products, resulting in safer compositions that can be fed to animals thereby resulting in animals with improved properties.

### BACKGROUND OF THE INVENTION

1. Field of the Invention

Disclosed herein are feed compositions, including avian feed compositions, as well as methods of making and using the compositions. Preferably, the compositions are made without animal components or animal derived products, resulting in safer compositions that can be fed to animals thereby resulting in animals with improved properties and which are safer and healthier for human consumption.

2. Description of the Related Art

Various animal health concerns are related to the diet of the animal. A number of animal diseases are spread or suspected to be spread via the use or consumption of products or materials derived from other animals. For example, animal feed made up of animal product or material derived from other animals can spread diseases to the consuming animal of the product. Also, the diet of the animal contributes to the overall health of the animal, for example, the health of an animal's immune system. There is a need for improved feed compositions that avoid spreading illness from one animal to another and which provide improved overall health and immunity for the animal.

Furthermore, humans consume many animals or animal products. It is increasingly important that the consumed products be free, as much as possible, of animal borne disease. Also, some animal products contain substances that can adversely affect human health. Cholesterol is one such substance. There is a need for animals and animal products with decreased amounts of such substances and which are safer for human consumption.

### SUMMARY OF THE INVENTION

Some embodiments relate to feed compositions. The compositions can include, for example, a pre-mix composition that can include about three percent by weight of the total avian feed composition, the premix composition can include purified essential and non-essential amino acids, vitamins, nutrients and minerals; maize in an amount of about sixty-seven to about seventy percent by weight of the total avian feed composition; and soybean meal (minimum about 44% protein) in an amount of about twenty-seven to about thirty percent by weight of the total avian feed composition. The pre-mix composition can be free of animal material or animal product, for example. The feed composition can be substantially free of animal-derived protein, for example.

Other embodiments relate to avian layer feed compositions. The avian layer feed compositions can include for example, a pre-mix composition of about three percent by weight of the total avian feed composition, the premix composition can include essential and non-essential amino acids, vitamins, nutrients and minerals; maize, wherein the maize makes up a percentage of the total avian layer feed composition, the percentage can be for example, about fifty-eight, about fifty-nine, about sixty-three, and about sixty-seven percent by weight of the total avian layer feed composition; soybean meal (minimum 44% protein), wherein the soybean meal makes up a percentage by weight of the total avian layer feed composition, the percentage can be for example, about eight, about fifteen, about eighteen, and about twenty percent by weight of the total avian layer feed composition; wheat bran, wherein the wheat bran makes up a percentage by weight of the total avian layer feed composition, the percentage can be for example, about eight and one half, about ten, about fifteen and one half, and about thirty percent by weight of the total avian layer feed composition; and lime stone in an amount from zero, about one, and about seven and one half percent by weight of the total avian layer feed composition.

Further embodiments relate to avian nutritional pre-mix compositions. The pre-mix compositions can include, for example, amino acids, such as, methionine, lysine, methionine+cysteine, arginine, tryptophan, glycine, histidine, isoleucine, phenylalanine, phenylalanine+tyrosine, threonine, valine, and the like; vitamins such as vitamin A (Vit A), vitamin B₁₂ (Vit B₁₂), vitamin D (Vit D), vitamin E (Vit E), vitamin K3 (Vit K3), biotin, niacin, riboflavin, pantothenic acid (B₅), pyridoxine (B₆), linoleic acid (Vit F) and folic acid; minerals such as calcium, phosphorous (total and available), manganese, phosphorous, zinc, potassium, iron, sodium, copper, magnesium, selenium, chloride, iodine, cobalt, and sulfur; nutrients, including, for example, choline; corn distillers dried grains with or without solubles; and one or more antioxidants.

In some aspects, the avian nutritional pre-mix composition can include vitamins in the following approximate amounts:

Vit A IU/kg 4,500,000;

Vit D3 IU/kg 950,000;

Vit E mg/kg 1600.00;

Vit K3 mg/kg 100.00;

Niacin mg/kg 146.90;

Riboflavin mg/kg 21.58;

Pantothenic acid mg/kg 22.81;

Pyridoxine mg/kg 10.21;

Folic acid mg/kg 0.57;

Linoleic acid (Vit F) % by weight 2.5;

Vit B12 mcg/kg 13.44; and

Biotin mcg/kg 0.57.

In some aspects, the avian nutritional pre-mix composition can include minerals in the following approximate amounts:

Calcium % 15.60;

Phosphorous (total) % by weight 10.50;

Phosphorous (available) % by weight 10.00;

Potassium % by weight 1.77;

Sodium % by weight 4.80;

Chloride by weight % 4.65;

Magnesium by weight % 0.22;

Sulfur by weight % 0.10;

Manganese mg/kg 29.96;

Zinc mg/kg 45.94;

Iron mg/kg 300.00;

Copper mg/kg 50.53;

Cobalt mg/kg 0.11;

Iodine mg/kg 0.46; and

Selenium mg/kg 2.00.

Also, in some aspects, the avian nutritional pre-mix composition can include amino acids in the following approximate amounts:

Methionine % by weight 2.70;

Lysine % 2.80;

Methionine+cysteine % by weight 1.25;

Arginine % by weight 1.75;

Tryptophan % by weight 0.29;

Glycine % by weight 2.74;

Histidine % by weight 1.02;

Isoleucine % by weight 1.52;

Phenylalanine % by weight 1.32;

Phenylalanine+tyrosine % by weight 2.30;

Threonine % by weight 1.20; and

Valine % by weight 1.82.

In further aspects, the avian nutritional pre-mix composition can include about 4.45 g/kg choline. In some aspects, the avian nutritional pre-mix composition can include about 2.5 mg/kg antioxidant. Furthermore, in some aspects, the avian nutritional pre-mix composition can include corn distillers dried grains or corn distillers dried grains and solubles in an amount of about 25%, 30%, 31%, 32%, 33%, 34%, 35%, or 40% by weight. Also, the corn distillers dried grains or corn distillers dried grains and solubles can be added in an amount that results the desired final weight of the pre-mix composition. In some aspects, it can be preferred to include corn distillers dried grains with solubles.

In some preferred aspects, the avian pre-mix composition can include the following:

vitamins in the following amounts:

Vit A IU/kg 4,500,000;

Vit D3 IU/kg 950,000;

Vit E mg/kg 1600.00;

Vit K3 mg/kg 100.00;

Niacin mg/kg 146.90;

Riboflavin mg/kg 21.58;

Pantothenic acid mg/kg 22.81;

Pyridoxine mg/kg 10.21;

Folic acid mg/kg 0.57;

Linoleic acid (Vit F) % by weight 2.5;

Vit B12 mcg/kg 13.44; and

Biotin mcg/kg 0.57.

amino acids in the following amounts:

Methionine % by weight 2.70,

Lysine % by weight 2.80,

Methionine+cysteine % by weight 1.25,

Arginine % by weight 1.75,

Tryptophan % by weight 0.29,

Glycine % by weight 2.74,

Histidine % by weight 1.02,

Isoleucine % by weight 1.52,

Phenylalanine % by weight 1.32,

Phenylalanine+tyrosine % by weight 2.30,

Threonine % by weight 1.20, and

Valine % by weight 1.82;

minerals in the following amounts:

Calcium % by weight 15.60,

Phosphorous (total) % by weight 10.50,

Phosphorous (available) % by weight 10.00,

Potassium % by weight 1.77,

Sodium % by weight 4.80,

Chloride % by weight 4.65,

Magnesium % by weight 0.22,

Sulfur % by weight 0.10,

Manganese mg/kg 29.96,

Zinc mg/kg 45.94,

Iron mg/kg 300.00,

Copper mg/kg 50.53,

Cobalt mg/kg 0.11,

Iodine mg/kg 0.46, and

Selenium mg/kg 2.00;

nutrients comprising about 4.45 g/kg choline;

about 2.5 mg/kg antioxidant; and

corn distillers dried grains with or without solubles. In some aspects, it can be preferred to include corn distillers dried grains with solubles.

In other aspects, the avian nutritional pre-mix composition can include vitamins in the following approximate amounts:

Vit A IU/kg 4,000,000;

Vit D3 IU/kg 850,000;

Vit E mg/kg 1500.00;

Vit K3 mg/kg 100.00;

Niacin mg/kg 146.90;

Riboflavin mg/kg 21.58;

Pantothenic acid mg/kg 22.81;

Pyridoxine mg/kg 10.21;

Folic acid mg/kg 0.57;

Linoleic acid (Vit F) % by weight 2.05

Vit B12 mcg/kg 15.00; and

Biotin mcg/kg 1.50.

In some other aspects, the avian nutritional pre-mix composition can include minerals in the following approximate amounts:

Calcium % by weight 14.60;

Phosphorous (total) % by weight 10.50;

Phosphorous (available) % by weight 10.00;

Potassium % by weight 1.77;

Sodium % by weight 4.60;

Chloride % by weight 4.45;

Magnesium % by weight 0.22;

Sulfur % by weight 0.10;

Manganese mg/kg 29.96;

Zinc mg/kg 45.94;

Iron mg/kg 300.00;

Copper mg/kg 50.53;

Cobalt mg/kg 0.11;

Iodine mg/kg 0.46; and

Selenium mg/kg 2.00.

In other aspects, the avian nutritional pre-mix composition can include amino acids in the following approximate amounts:

Methionine % by weight 2.80;

Lysine % by weight 3.00;

Methionine+cysteine % by weight 1.50;

Arginine % by weight 1.75;

Tryptophan % by weight 0.29;

Glycine % by weight 2.74;

Histidine % by weight 1.02;

Isoleucine % by weight 1.52;

Phenylalanine % by weight 1.32;

Phenylalanine+tyrosine % by weight 2.30;

Threonine % by weight 1.20; and

Valine % by weight 1.82.

In some aspects, the avian nutritional pre-mix composition can include about 3.78 g/kg choline.

Also, in some aspects, the avian nutritional pre-mix composition can include corn distillers dried grains or corn distillers dried grains and solubles in an amount of about 25%, 30%, 31%, 32%, 33%, 34%, 35%, or 40% by weight. Also, the corn distillers dried grains or corn distillers dried grains and solubles can be added in an amount that results the desired final weight of the pre-mix composition. In some aspects, it can be preferred to include corn distillers dried grains with solubles.

In some preferred aspects, the avian nutritional pre-mix composition can include the following:

Vitamins in the following amounts:

Vit A IU/kg 4,000,000;

Vit D3 IU/kg 850,000;

Vit E mg/kg 1500.00;

Vit K3 mg/kg 100.00;

Niacin mg/kg 146.90;

Riboflavin mg/kg 21.58;

Pantothenic acid mg/kg 22.81;

Pyridoxine mg/kg 10.21;

Folic acid mg/kg 0.57;

Linoleic acid (Vit F) % by weight 2.05

Vit B12 mcg/kg 15.00; and

Biotinmcg/kg 1.50.

amino acids in the following amounts:

Methionine % by weight 2.80;

Lysine % by weight 3.00;

Methionine+cysteine % by weight 1.50;

Arginine % by weight 1.75;

Tryptophan % by weight 0.29;

Glycine % by weight 2.74;

Histidine % by weight 1.02;

Isoleucine % by weight 1.52;

Phenylalanine % by weight 1.32;

Phenylalanine+tyrosine % by weight 2.30;

Threonine % by weight 1.20; and

Valine % by weight 1.82.

minerals in the following amounts:

Calcium % by weight 14.60;

Phosphorous (total) % by weight 10.50;

Phosphorous (available) % by weight 10.00;

Potassium % by weight 1.77;

Sodium % by weight 4.60;

Chloride % by weight 4.45;

Magnesium % by weight 0.22;

Sulfur % by weight 0.10;

Manganese mg/kg 29.96;

Zinc mg/kg 45.94;

Iron mg/kg 300.00;

Copper mg/kg 50.53;

Cobalt mg/kg 0.11;

Iodine mg/kg 0.46; and

Selenium mg/kg 2.00.

nutrients comprising about 3.78 g/kg choline;

about 2.5 mg/kg antioxidant; and

corn distillers dried grains with or without solubles. In some aspects, it can be preferred to include corn distillers dried grains with solubles.

Still other embodiments relate to avian broiler feed compositions that include a pre-mix composition as described above or elsewhere herein.

Further embodiments relate to methods of making a poultry broiler feed composition. The methods can include combining a pre-mix composition as described above or elsewhere with maize and soybean meal, wherein the feed composition with the combined ingredients can have about 3% by weight of the broiler pre-mix composition, about 67% or about 70% maize by weight, and about 30% or 27% by weight soybean meal.

Other embodiments relate to avian layer feed compositions that include a pre-mix of composition as described above or elsewhere herein.

Still further embodiments relate to methods of making a poultry layer feed composition, comprising combining the pre-mix composition as described above or elsewhere herein with maize and soybean meal, wherein the feed composition with the combined ingredients can have about 3% by weight of the layer pre-mix composition, about 58%, 59%, 63% or 67% maize by weight, and about 30% or 27% by weight soybean meal.

Some embodiments relate to methods of raising an egg laying avian. The methods can include, for example, feeding to the avian egg layer during the first 0 to 8 weeks of the life of the avian, the avian layer feed composition as described above or elsewhere herein, preferably an avian layer composition that includes about sixty-seven percent by weight maize, about twenty percent by weight soybean meal, about ten percent by weight wheat bran, and about three percent by weight premix composition, wherein the avian layer composition can include little or no lime stone; feeding to the avian egg layer during weeks 8 to 20 of the life of the avian, an avian layer feed composition as described above or elsewhere herein, preferably avian layer composition that includes about fifty-eight percent by weight maize, about eight percent by weight soybean meal, about thirty percent by weight wheat bran, about one percent by weight lime stone, and about three percent by weight premix composition; feeding to the avian egg layer during weeks 21 to 42 of the life of the avian, an avian layer feed composition as described above or elsewhere herein, preferably avian layer composition that includes about sixty-three percent by weight maize, about eighteen percent by weight soybean meal, about eight and one half percent by weight wheat bran, about seven and one half percent by weight lime stone, and about three percent by weight premix composition; and feeding to the avian egg layer after 42 weeks of the life of the avian, an avian layer feed as described above or elsewhere herein, preferably an avian layer composition that includes about fifty-nine percent by weight maize, about fifteen percent by weight soybean meal, about fifteen and one half percent by weight wheat bran, about seven and one half percent by weight limestone, and about three percent by weight premix composition. In preferred aspects, the avian can be a chicken.

Other embodiments relate to methods of raising a broiler avian. The methods can include, for example, feeding to the avian during a starter period weeks of the life of the avian, an avian feed composition as described above or elsewhere herein, preferably the avian composition can include about sixty-seven percent by weight maize, about thirty percent by weight soybean meal, and about three percent by weight premix composition; and feeding to the avian during a finisher period weeks of the life of the avian, an avian feed composition as described above or elsewhere herein, preferably the avian composition can include about seventy percent by weight maize, about twenty-seven percent by weight soybean meal, and about three percent by weight premix composition. In some aspects, the starter period can be a period of time of time from birth to about three weeks. In some aspects, the finisher period can be a period of time of time from about three weeks to about 7 weeks.

Still further embodiments relate to methods of reducing the amount of cholesterol in a poultry egg, which methods can include feeding to said poultry a diet substantially free of animal derived protein.

Some embodiments relate to methods of reducing the amount of cholesterol in a poultry, which methods can include feeding to said poultry a diet substantially free of animal derived protein.

Further embodiments relate to poultry feed systems, which systems can include, for example, a feed containment device; and an avian feed composition as described above, or elsewhere herein.

### DETAILED DESCRIPTION OF THE PREFERRED EMBODIMENT

Disclosed herein are feed compositions, including avian feed compositions, as well as methods of making and using the compositions. Preferably, the compositions are made without animal components or animal derived products, resulting in safer compositions that can be fed to animals thereby resulting in animals with improved properties. Furthermore, the compositions can provide a healthy diet for the animals, including a diet with substantial protein that is free of animal derived product.

For example, the animals can be healthier and have improved immunity because the animals have not consumed feed made with materials from other animals. Further, the animals can be safer for consumption for the same reasons. For example, the animals can have lower cholesterol content in their bodies and produce products with less cholesterol. In the case of poultry, the poultry themselves can have less cholesterol, and they can produce eggs with less cholesterol, for example. Furthermore, it has been observed that poultry that consume the instant compositions have improved feed conversions and have higher levels of growth factors, for example, five to eight times, than seen in animals fed with animal source protein feed compositions.

Some embodiments relate to feed compositions for an animal. The animal can be any animal. In preferred embodiments the animal can be for example, an avian or a bovine. Preferably, the avian can be poultry, including a turkey or a chicken. The bovine can be any bovine, for example, a cow.

The feed compositions can include various ingredients that can be combined to obtain the complete feed composition. For example, the feed composition can include a pre-mix composition, which is more fully described below. Examples of other ingredients can include maize, soybean meal, wheat bran, and limestone (for example from oyster shells). One or more of the ingredients can be excluded in some aspects and any combination of ingredients can be used. The ingredients can be combined with any desirable percentage of each component. It should be noted that the pre-mix composition can include some of the same ingredients that are included in the complete feed composition. For example, the pre-mix composition can include grain, grain components, or soybean meal and one or more of those ingredients also additionally can be included as part of the complete feed composition.

In some embodiments, the composition includes about three percent by weight of the pre-mix composition and about ninety-seven percent other ingredients. The pre-mix composition can include, for example, purified essential and non-essential amino acids, vitamins, nutrients, minerals, and an additional component or combination of components, such as corn, corn distillers dried grains with and without solubles, soybean meal and other grains. In some aspects, it can be preferred to include corn distillers dried grains with solubles. In other aspects, the composition can include about one, two, four, five, six, seven, 10, 15, or more than 15 percent by weight of the pre-mix composition.

The pre-mix composition can include amino acids or amino acid combinations such as methionine, lysine, methionine+cysteine, arginine, tryptophan, glycine, histidine, isoleucine, phenylalanine, phenylalanine+tyrosine, threonine, and valine; vitamins such as Vit A, Vit B₁₂, Vit D, Vit E, Vit K3, biotin, niacin, riboflavin, pantothenic acid (B₅), pyridoxine (B₆), linoleic acid (Vit F) and folic acid; minerals such as calcium, phosphorous (total and available), manganese, phosphorous, zinc, potassium, iron, sodium, copper, magnesium, selenium, chloride, iodine, cobalt, and sulfur; nutrients such as choline; one or more antioxidants; one or more additional components such as corn distillers dried grains with or without solubles, soybean meal, corn or other grains. In some aspects, it can be preferred to include corn distillers dried grains with solubles. One or more of the above-listed components can be excluded in some aspects of the embodiments. The above-listed components can be included in any combination and in any amounts in the pre-mix composition. Some exemplary amounts are described below.

In some embodiments, the feed composition also can include, in addition to the pre-mix composition, maize in an amount of about sixty-seven to about seventy percent by weight. Alternatively, in some aspects the compositions can include about fifty, fifty-five, sixty, sixty-five, seventy, seventy-five percent by weight of maize, or any value within those numbers (e.g., about 50-75%, 60-75%, 60-70%, etc.). The feed composition preferably can include soybean meal in an amount of about twenty-seven to about thirty percent by weight, and preferably the soybean meal includes about 44% protein. In some aspects, the soybean meal can total about fifteen, twenty, twenty-five, twenty-six, twenty-eight, twenty-nine, thirty-five or forty percent by weight of the total composition; or fall within range of those numbers (e.g., 15-40%, 20-35%, 25-32%, etc.). Furthermore, in some embodiments the feed composition can include wheat bran in amount of about eight and one half percent to about thirty percent by weight. In some aspects, the compositions can include about two, three, four, five, six, seven, eight, nine, ten, or fifteen percent by weight wheat bran and any other percentage within that range. In some embodiments, the feed composition can include limestone in an amount of about zero or one percent to about seven and one half percent by weight. In some aspects, the compositions can include about two, three, four, five, six, seven, eight, nine or ten percent by weight limestone, or any range within those numbers. Again, not all of the ingredients are used in all aspects of the embodiments, and the ingredients can be used in any combination.

Avian Layer Feed Compositions

Some particular embodiments relate to avian feed compositions for an egg laying avian, referred to herein as a “layer.” The avian layer feed compositions can include, for example, a pre-mix composition, maize, soybean meal, wheat bran and limestone.

Preferably, the avian layer feed compositions can include a pre-mix composition of about three percent by weight of the total avian feed composition, the premix composition comprising essential and non-essential amino acids, vitamins, nutrients, minerals and other component(s) as described herein. The pre-mix composition can also include corn distillers dried grains with and without solubles, for example. In some aspects, it can be preferred to include corn distillers dried grains with solubles.

In preferred aspects, the avian layer pre-mix composition can include vitamins in the following amounts as shown in Table 1:

TABLE 1

| | | | | | |
|---|---|---|---|---|---|
| Vit A | 4,500,000 | Niacin | 146.90 | Folic acid | 0.57 |
| IU/kg | | mg/kg | | mg/kg | |
| Vit D3 | 950,000 | Riboflavin | 21.58 | Vit B12 | 13.44 |
| IU/kg | | mg/kg | | mcg/Kg | |
| Vit E | 1600.00 | Pantothenic | 22.81 | Biotin | 0.57 |
| mg/kg | | acid mg/kg | | mcg/kg | |
| Vit K3 | 100.00 | Pyridoxine | 10.21 | Linoleic Acid | 2.5% |
| mg/kg | | mg/kg | | (F) by weight | |

IU: International Units
mcg: microgram

In preferred aspects, the avian layer pre-mix composition can include minerals in the following amounts as shown in Table 2 (percentages are shown as percent by weight):

TABLE 2

| | | | | | |
|---|---|---|---|---|---|
| Calcium % | 15.60 | Sodium % | 4.80 | Manganese | 29.96 |
| | | | | mg/kg | |
| Phosphorous | 10.50 | Chloride % | 4.65 | Zinc mg/kg | 45.94 |
| (total) % | | | | | |
| Phosphorous | 10.00 | Magnesium % | 0.22 | Iron mg/kg | 300.00 |
| (available) % | | | | | |
| Potassium % | 1.77 | Sulfur % | 0.10 | Copper | 50.53 |
| | | | | mg/kg | |
| Cobalt mg/kg | 0.11 | Iodine mg/kg | 0.46 | Selenium | 2.00 |
| | | | | mg/kg | |

In preferred aspects, the avian layer pre-mix composition can include amino acids in the following amounts (percent by weight) as shown in Table 3:

TABLE 3

| | | | | | |
|---|---|---|---|---|---|
| Methionine % | 2.70 | Tryptophan % | 0.29 | Phenylalanine % | 1.32 |
| Lysine % | 2.80 | Methionine + | 1.25 | Phenylalanine + | 2.30 |
| | | cysteine % | | tyrosine % | |
| Glycine % | 2.74 | Histidine % | 1.02 | Threonine % | 1.20 |
| Arginine % | 1.75 | Isoleucine % | 1.52 | Valine % | 1.82 |

In preferred aspects, the avian layer pre-mix feed composition can include about 4.45 g/kg choline, and about 2.5 mg/kg antioxidant.

The avian layer pre-mix composition can further include corn distillers dried grains with and without solubles, for example in whatever amount is necessary to arrive at the desired final weight for the pre-mix composition. In some aspects, it can be preferred to include corn distillers dried grains with solubles.

As noted above, in addition to the pre-mix composition, the avian layer feed composition can include, for example, maize, soybean meal, wheat bran and limestone. In some aspects, the avian layer feed composition can include maize in a percentage of about fifty-eight, about fifty-nine, about sixty-three, or about sixty-seven percent by weight of the total avian layer feed composition.

Also, the avian layer feed composition further can include soybean meal, preferably with a minimum of about forty-four percent protein, wherein the soybean meal makes up a percentage of about eight, about fifteen, about eighteen, or about twenty percent by weight of the total avian layer feed composition.

Additionally, the avian layer feed composition can include wheat bran in a percentage of about eight and one half, about ten, about fifteen and one half, or about thirty percent by weight of the total avian layer feed composition.

Furthermore, the avian layer feed composition can include lime stone in an amount from zero, about one, or about seven and one half percent by weight of the total avian layer feed composition.

Avian Broiler Feed Compositions

Other particular embodiments relate to avian feed compositions for an avian for consumption, referred to herein as a “broiler.” The avian broiler feed compositions can include, for example, a pre-mix composition, maize, and soybean meal.

Preferably, the avian broiler feed compositions can include a pre-mix composition of about three percent by weight of the total avian feed composition, the premix composition comprising essential and non-essential amino acids, vitamins, nutrients, minerals, additional component(s) as described herein. The pre-mix composition can also include corn distillers dried grains with and without solubles, for example. In some aspects, it can be preferred to include corn distillers dried grains with solubles.

In preferred aspects, the avian broiler pre-mix composition can include vitamins in the following amounts as shown in Table 4:

TABLE 4

| | | | | | |
|---|---|---|---|---|---|
| Vit A | 4,000,000 | Niacin | 146.90 | Folic acid | 0.57 |
| IU/kg | | mg/kg | | mg/kg | |
| Vit D3 | 850,000 | Riboflavin | 21.58 | Vit B12 | 15.00 |
| IU/kg | | mg/kg | | mcg/Kg | |
| Vit E | 1500.00 | Pantothenic | 22.81 | Biotin | 1.50 |
| mg/kg | | acid mg/kg | | mcg/kg | |
| Vit K3 | 100.00 | Pyridoxine | 10.21 | Linoleic Acid | 2.05% |
| mg/kg | | mg/kg | | (F) by weight, | |

IU: International Units

In preferred aspects, the avian broiler pre-mix composition can include minerals in the following amounts as shown in Table 5 (percentages are shown as percent by weight):

TABLE 5

| | | | | | |
|---|---|---|---|---|---|
| Calcium % | 14.60 | Sodium % | 4.60 | Manganese | 29.96 |
| | | | | mg/kg | |
| Phosphorous | 10.50 | Chloride % | 4.45 | Zinc mg/kg | 45.94 |
| (total) % | | | | | |
| Phosphorous | 10.00 | Magnesium % | 0.22 | Iron mg/kg | 300.00 |
| (available) % | | | | | |
| Potassium % | 1.77 | Sulfur % | 0.10 | Copper | 50.53 |
| | | | | mg/kg | |
| Cobalt mg/kg | 0.11 | Iodine mg/kg | 0.46 | Selenium | 2.00 |
| | | | | mg/kg | |

In preferred aspects, the avian broiler pre-mix composition can include amino acids in the following amounts (percent by weight) as shown in Table 6:

TABLE 6

| | | | | | |
|---|---|---|---|---|---|
| Methionine % | 2.80 | Tryptophan % | 0.29 | Phenylalanine % | 1.32 |
| Lysine % | 3.00 | Methionine + | 1.50 | Phenylalanine + | 2.30 |
| | | cysteine % | | tyrosine % | |
| Glycine % | 2.74 | Histidine % | 1.02 | Threonine % | 1.20 |
| Arginine % | 1.75 | Isoleucine % | 1.52 | Valine % | 1.82 |

In preferred aspects, the avian broiler pre-mix feed composition can include about 3.78 g/kg choline, and about 2.5 mg/kg antioxidant.

The avian broiler pre-mix composition can further include corn distillers dried grains with and without solubles, for example in whatever amount is necessary to arrive at the desired final weight for the pre-mix composition. For example, if final amount of pre-mix is thirty kilograms, the amount of corn distillers dried grains with and without solubles that is added would be the amount necessary to arrive at a pre-mix total weight of 30 kilograms. In some aspects, it can be preferred to include corn distillers dried grains with solubles.

As noted above, in addition to the pre-mix composition, the avian broiler feed composition can also include, for example, maize, and soybean meal. In some aspects, the complete feed composition can include maize in a percentage of about sixty-seven or about seventy percent by weight of the total avian broiler feed composition; and soybean meal, preferably with a minimum of about forty-four percent protein, wherein the soybean meal makes up a percentage of about thirty percent or about twenty-seven percent by weight of the total avian broiler feed composition.

Some embodiments also relate to methods of making the pre-mix and feed compositions. The compositions can be made by any suitable method of mixing. Preferably, the compositions can be made by mixing the contents in a vertical steel mixer. Any mixing time can be used which is sufficient to mix the ingredients. An exemplary mixing time is about thirty to about forty-five minutes.

Raising or Feeding an Avian Layer

Still further embodiments relate to methods of raising or feeding an avian layer. The methods can include feeding to the avian layer any of the layer feed compositions described herein. Preferably, compositions with differing amounts of components are fed to the avian at different time periods in the life of the avian. Exemplary time periods include week zero to about week eight, about weeks eight or nine to about week twenty, about week twenty-one to about week forty-two, and any time after about week forty-two.

In preferred aspects, the methods can include feeding the avian layer during about the first zero to eight weeks of the life of the layer any of the layer feed compositions described herein. Preferably, the avian layer feed composition can include about sixty-seven percent by weight maize, about twenty percent by weight soybean meal, about ten percent by weight wheat bran, about three percent by weight premix composition, and the avian layer composition can include little or no lime stone.

In other preferred aspects, the methods can include feeding the avian layer during about weeks eight or nine to about twenty of the life of the layer any of the layer feed compositions described herein. Preferably, the avian layer feed composition can include feeding to the avian egg layer about fifty-eight percent by weight maize, about eight percent by weight soybean meal, about thirty percent by weight wheat bran, about one percent by weight lime stone, and about three percent by weight premix composition.

In some preferred aspects, the methods can include feeding the avian layer during about week twenty-one to about week forty-two of the life of the layer any of the layer feed compositions described herein. Preferably, the avian layer feed composition can include feeding to the avian egg layer about sixty-three percent by weight maize, about eighteen percent by weight soybean meal, about eight and one half percent by weight wheat bran, about seven and one half percent by weight lime stone, and about three percent by weight premix composition.

In still other preferred aspects, the methods can include feeding the avian layer after about week forty-two of the life of the layer any of the layer feed compositions described herein. Preferably, the avian layer feed composition can include feeding to the avian egg layer about fifty-nine percent by weight maize, about fifteen percent by weight soybean meal, about fifteen and one half percent by weight wheat bran, about seven and one half percent by weight limestone, and about three percent by weight premix composition.
Raising or Feeding an Avian Broiler

Further embodiments relate to methods of raising or feeding an avian broiler. The methods can include feeding to the avian broiler any of the layer feed compositions described herein. Preferably, compositions with differing amounts of components are fed to the avian at different time periods in the life of the avian. For example, during a starter period the composition can be different from the composition used during a finisher period. The starter period can be, for example, from birth to about 1, 2, 3, or 4 weeks, preferably from zero to three weeks of life, and the finisher period can be, for example, for a 2, 3, 4 or 5 week period after a starter period. Preferably, the finisher period can be for a period from about week 3 or week 4 of life until about week 5, 6, 7, 8 or 9 of life, most preferably from about week 3 until about week 6 or 7.

In preferred aspects, the methods can include feeding the avian broiler during the starter period a composition that includes a broiler pre-mix composition in an amount of about three percent by weight, maize in an amount of about sixty-seven percent by weight, and soybean meal in an amount of about thirty percent by weight. Preferably, during the finisher period the methods can include feeding the avian broiler a composition that includes broiler pre-mix composition in an amount of about three percent by weight, maize in an amount of about seventy percent by weight, and soybean meal in an amount of about twenty-seven percent by weight.

Further embodiments relate to methods of reducing the amount of cholesterol in a poultry egg. The methods can include, for example, feeding to the poultry a diet substantially free of animal derived protein. For example, the methods can include feeding to the poultry any of the compositions described herein.

Other embodiments relate to methods of reducing the amount of cholesterol in a poultry. For example the methods can include feeding to the poultry a diet substantially free of animal derived protein. For example, the methods can include feeding to the poultry any of the compositions described herein.

Some embodiments relate to a poultry feed system. For example the system can include a feed containment device; and an avian feed composition as described herein.

### EXAMPLES

### Example 1

### Broiler Pre-Mix Composition

A broiler pre-mix composition was made by mixing the following ingredients in the following amounts as set forth in Table 7:

TABLE 7

| | | | |
|---|---|---|---|
| Methionine % | 2.80 | Vit A IU/kg | 4,000,000 |
| Lysine % | 3.00 | Vit D3 IU/kg | 850,000 |
| Methionine + cysteine % | 1.50 | Vit E mg/kg | 1500 |
| Arginine % | 1.75 | Vit K3 mg/kg | 100 |
| Tryptophan % | 0.29 | Niacin mg/kg | 146.9 |
| Glycine % | 2.74 | Riboflavin mg/kg | 21.58 |
| Histidine % | 1.02 | Pantothenic acid | 22.81 |
| Isoleucine % | 1.52 | mg/kg | |
| Phenylalanine % | 1.32 | Pyridoxine mg/kg | 10.21 |
| Phenylalanine + tyrosine % | 2.30 | Choline g/kg | 3.78 |
| Threonine % | 1.20 | Folic acid mg/kg | 0.57 |
| Valine % | 1.82 | Vit B12 mcg/Kg | 15.00 |
| Calcium % | 14.60 | Biotin mcg/kg | 1.50 |
| Phosphorous (total) % | 10.50 | Linoleic acid % | 2.05 |
| Phosphorous (Available) % | 10.00 | Manganese mg/kg | 29.96 |
| Potassium % | 1.77 | Zinc mg/kg | 45.94 |
| Sodium % | 4.60 | Iron mg/kg | 300 |
| Chloride % | 4.45 | Copper mg/kg | 50.53 |
| Magnesium % | 0.22 | Cobalt mg/kg | 0.11 |
| Sulfur % | 0.10 | Iodine mg/kg | 0.46 |

| | | |
|---|---|---|
| Corn distillers dried grains with | Selenium mg/kg | 2.00 |
| solubles were added to bring the | Antioxidant mg/kg | 2.5 |
| total weight of the pre-mix to | | |
| 100% of the desired weight (about | | |
| 32.5% in this particular example) | | |

### Example 2

### Broiler Starter Feed

A broiler avian starter feed was made by mixing the following ingredients by weight, as set forth in Table 8:

TABLE 8

| (kg/ton) | Starter |
|---|---|
| Broiler premix 3% | 30 |
| Maize | 670 |
| Soya min-44 | 300 |
| Total | 1000 |

### Example 3

### Broiler Finisher Feed

A broiler avian finisher feed was made by mixing the following ingredients by weight, as set forth in Table 9:

TABLE 9

| (kg/ton) | Finisher |
|---|---|
| Broiler premix 3% | 30 |
| Maize | 700 |
| Soya min-44 | 270 |
| Total | 1000 |

### Example 4

### Broiler Feeding Protocol

Broiler poultry were fed the following starter and finisher compositions as shown in Table 10:

TABLE 10

| | | Finisher (3 to about 6-7 |
|---|---|---|
| (kg/ton) | Starter (0-3 weeks) | weeks) |
| Broiler premix 3% | 30 | 30 |
| Maize | 670 | 700 |
| Soya min-44 | 300 | 270 |
| Total | 1000 | 1000 |

### Example 5

### Layer Pre-Mix Composition

A layer pre-mix composition was made by mixing the following ingredients in the following amounts as set forth in Table 11:

TABLE 11

| | | | |
|---|---|---|---|
| Methionine % | 2.70 | Vit A IU/kg | 4,500,000 |
| Lysine % | 2.80 | Vit D3 IU/kg | 950,000 |
| Methionine + cysteine % | 1.25 | Vit E mg/kg | 1600 |
| Arginine % | 1.75 | Vit K3 mg/kg | 100 |
| Tryptophan % | 0.29 | Niacin mg/kg | 146.9 |
| Glycine % | 2.74 | Riboflavin mg/kg | 21.58 |
| Histidine % | 1.02 | Pantothenic acid | 22.81 |
| Isoleucine % | 1.52 | mg/kg | |
| Phenylalanine % | 1.32 | Pyridoxine mg/kg | 10.21 |
| Phenylalanine + tyrosine % | 2.30 | Choline g/kg | 4.45 |
| Threonine % | 1.20 | Folic acid mg/kg | 0.57 |
| Valine % | 1.82 | Vit B12 mcg/Kg | 13.44 |
| Calcium % | 15.60 | Biotin mcg/kg | 0.57 |
| Phosphorous (total) % | 10.50 | Linoleic acid % | 2.50 |
| Phosphorous (Available) % | 10.00 | Manganese mg/kg | 29.96 |
| Potassium % | 1.77 | Zinc mg/kg | 45.94 |
| Sodium % | 4.80 | Iron mg/kg | 300 |
| Chloride % | 4.65 | Copper mg/kg | 50.53 |
| Magnesium % | 0.22 | Cobalt mg/kg | 0.11 |
| Sulfur % | 0.10 | Iodine mg/kg | 0.46 |

| | | |
|---|---|---|
| Corn distillers dried grains with | Selenium mg/kg | 2.00 |
| solubles were added to bring the | Antioxidant mg/kg | 2.5 |
| total weight of the pre-mix to | | |
| 100% of the desired weight (about | | |
| 31.65% in this particular example) | | |

### Example 6

### Layer Feed Compositions and Protocol for the Same

Avian layer feed compositions were for use at various time periods were made by mixing the below-specified ingredients. The compositions were fed to avian layers during the specified time periods.

TABLE 12

| (kg/ton) | 0-8 wks | 8-20 wks | 21-42 wks | After 42 wks |
|---|---|---|---|---|
| Layer premix 3% | 30 | 30 | 30 | 30 |
| Maize | 670 | 580 | 630 | 590 |
| Soya bean (44%) | 200 | 80 | 180 | 150 |
| Wheat bran | 100 | 300 | 85 | 155 |
| Lime stone (oyster | | | | |
| shells | — | 10 | 75 | 75 |
| Total: | 1000 | 1000 | 1000 | 1000 |

What is claimed is:

1. A feed composition, comprising:
a pre-mix composition comprising about three percent by weight of the total avian feed composition, the premix composition comprising purified essential and non-essential amino acids, vitamins, nutrients and minerals;
maize in an amount of about sixty-seven to about seventy percent by weight of the total avian feed composition; and
soybean meal (minimum about 44% protein) in an amount of about twenty-seven to about thirty percent by weight of the total avian feed composition.

2. The feed composition of claim 1, wherein the pre-mix composition is free of animal material or product.

3. The feed composition of claim 1, wherein said feed composition is substantially free of animal-derived protein.

4. An avian layer feed composition, comprising:
a pre-mix composition of about three percent by weight of the total avian feed composition, the premix composition comprising essential and non-essential amino acids, vitamins, nutrients and minerals;
maize, wherein the maize makes up a percentage of the total avian layer feed composition, the percentage selected from the group consisting of about fifty-eight, about fifty-nine, about sixty-three, and about sixty-seven percent by weight of the total avian layer feed composition;
soybean meal (minimum 44% protein), wherein the soybean meal makes up a percentage by weight of the total avian layer feed composition, the percentage selected from the group consisting of about eight, about fifteen, about eighteen, and about twenty percent by weight of the total avian layer feed composition;
wheat bran, wherein the wheat bran makes up a percentage by weight of the total avian layer feed composition, the percentage selected from the group consisting of about eight and one half, about ten, about fifteen and one half, and about thirty percent by weight of the total avian layer feed composition; and
lime stone in an amount selected from zero, about one, and about seven and one half percent by weight of the total avian layer feed composition.

5. An avian nutritional pre-mix composition, comprising:
amino acids selected from the group consisting of methionine, lysine, methionine+cysteine, arginine, tryptophan, glycine, histidine, isoleucine, phenylalanine, phenylalanine+tyrosine, threonine, and valine;
vitamins selected from the group consisting of Vit A, Vit B₁₂, Vit D, Vit E, Vit K3, biotin, niacin, riboflavin, pantothenic acid (B₅), pyridoxine (B₆), linoleic acid (Vit F) and folic acid;
minerals selected from the group consisting of calcium, phosphorous (total and available), manganese, phosphorous, zinc, potassium, iron, sodium, copper, magnesium, selenium, chloride, iodine, cobalt, and sulfur;
nutrients, comprising choline;
corn distillers dried grains with or without solubles; and
one or more antioxidants.

6. The avian nutritional pre-mix composition of claim 5, wherein the pre-mix composition comprises vitamins in the following approximate amounts:
Vit A IU/kg 4,500,000;
Vit D3 IU/kg 950,000;
Vit E mg/kg 1600.00;
Vit K3 mg/kg 100.00;
Niacin mg/kg 146.90;
Riboflavin mg/kg 21.58;
Pantothenic acid mg/kg 22.81;
Pyridoxine mg/kg 10.21;
Folic acid mg/kg 0.57;
Linoleic acid (Vit F) % by weight 2.5;
Vit B₁₂ mcg/kg 13.44; and
Biotin mcg/kg 0.57.

7. The avian nutritional pre-mix composition of claim 5, wherein the pre-mix composition comprises minerals in the following approximate amounts:
Calcium % 15.60;
Phosphorous (total) % by weight 10.50;
Phosphorous (available) % by weight 10.00;
Potassium % by weight 1.77;
Sodium % by weight 4.80;
Chloride by weight % 4.65;
Magnesium by weight % 0.22;
Sulflur by weight % 0.10;
Manganese mg/kg 29.96;
Zinc mg/kg 45.94;
Iron mg/kg 300.00;
Copper mg/kg 50.53;
Cobalt mg/kg 0.11;
Iodine mg/kg 0.46; and
Selenium mg/kg 2.00.

8. The avian nutritional pre-mix composition of claim 5, wherein the pre-mix composition comprises amino acids in the following approximate amounts:
Methionine % by weight 2.70;
Lysine % 2.80;
Methionine+cysteine % by weight 1.25;
Arginine % by weight 1.75;
Tryptophan % by weight 0.29;
Glycine % by weight 2.74;
Histidine % by weight 1.02;
Isoleucine % by weight 1.52;
Phenylalanine % by weight 1.32;
Phenylalanine+tyrosine % by weight 2.30;
Threonine % by weight 1.20; and
Valine % by weight 1.82.

9. The avian nutritional pre-mix composition of claim 5, wherein the pre-mix composition comprises about 4.45 g/kg choline.

10. The avian nutritional pre-mix composition of claim 5, wherein the composition comprises corn distillers dried grains or corn distillers dried grains and solubles in an amount of about 25%, 30%, 31%, 32%, 33%, 34%, 35%, or 40% by weight.

11. The avian pre-mix composition of claim 5, comprising: vitamins in the following amounts:
Vit A IU/kg 4,500,000;
Vit D3 IU/kg 950,000;
Vit E mg/kg 1600.00;
Vit K3 mg/kg 100.00;
Niacin mg/kg 146.90;
Riboflavin mg/kg 21.58;
Pantothenic acid mg/kg 22.81;
Pyridoxine mg/kg 10.21;
Folic acid mg/kg 0.57;
Linoleic acid (Vit F) % by weight 2.5;
Vit B₁₂ mcg/kg 13.44; and
Biotin mcg/kg 0.57.
amino acids in the following amounts:
Methionine % by weight 2.70,
Lysine % by weight 2.80,
Methionine+cysteine % by weight 1.25,
Arginine % by weight 1.75,
Tryptophan % by weight 0.29,
Glycine % by weight 2.74,
Histidine % by weight 1.02,
Isoleucine % by weight 1.52,
henylalanine % by weight 1.32,
Phenylalanine+tyrosine % by weight 2.30,
Threonine % by weight 1.20, and
Valine % by weight 1.82;
minerals in the following amounts:
Calcium % by weight 15.60,
Phosphorous (total) % by weight 10.50,
Phosphorous (available) % by weight 10.00,
Potassium % by weight 1.77,
Sodium % by weight 4.80,
Chloride % by weight 4.65,
Magnesium % by weight 0.22,
Sulfur % by weight 0.10,
Manganese mg/kg 29.96,
Zinc mg/kg 45.94,
Iron mg/kg 300.00,
Copper mg/kg 50.53,
Cobalt mg/kg 0.11,
Iodine mg/kg 0.46, and
Selenium mg/kg 2.00;
nutrients comprising about 4.45 g/kg choline;
about 2.5 mg/kg antioxidant; and
corn distillers dried grains with or without solubles.

12. The avian nutritional pre-mix composition of claim 5, wherein the pre-mix composition comprises vitamins in the following approximate amounts:
Vit A IU/kg 4,000,000;
Vit D3 IU/kg 850,000;
Vit E mg/kg 1500.00;
Vit K3 mg/kg 100.00;
Niacin mg/kg 146.90;
Riboflavin mg/kg 21.58;
Pantothenic acid mg/kg 22.81;
Pyridoxine mg/kg 10.21;
Folic acid mg/kg 0.57;
Linoleic acid (Vit F) % by weight 2.05
Vit B₁₂ mcg/kg 15.00; and
Biotin mcg/kg 1.50.

13. The avian nutritional pre-mix composition of claim 5, wherein the pre-mix composition comprises minerals in the following approximate amounts:
Calcium % by weight 14.60;
Phosphorous (total) % by weight 10.50;
Phosphorous (available) % by weight 10.00;
Potassium % by weight 1.77;
Sodium % by weight 4.60;
Chloride % by weight 4.45;
Magnesium % by weight 0.22;
Sulfur % by weight 0.10;
Manganese mg/kg 29.96;
Zinc mg/kg 45.94;
Iron mg/kg 300.00;
Copper mg/kg 50.53;
Cobalt mg/kg 0.11;
Iodine mg/kg 0.46; and
Selenium mg/kg 2.00.

14. The avian nutritional pre-mix composition of claim 5, wherein the pre-mix composition comprises amino acids in the following approximate amounts:
Methionine % by weight 2.80;
Lysine % by weight 3.00;
Methionine+cysteine % by weight 1.50;
Arginine % by weight 1.75;
Tryptophan % by weight 0.29;
Glycine % by weight 2.74;
Histidine % by weight 1.02;
Isoleucine % by weight 1.52;
Phenylalanine % by weight 1.32;
Phenylalanine+tyrosine % by weight 2.30;
Threonine % by weight 1.20; and
Valine % by weight 1.82.

15. The avian nutritional pre-mix composition of claim 5, wherein the composition comprises corn distillers dried grains or corn distillers dried grains and solubles in an amount of about 25%, 30%, 31%, 32%, 33%, 34%, 35%, or 40% by weight.

16. The avian nutritional pre-mix composition of claim 5, comprising:
Vitamins in the following amounts:
Vit A IU/kg 4,000,000;
Vit D3 IU/kg 850,000;
Vit E mg/kg 1500.00;
Vit K3 mg/kg 100.00;
Niacin mg/kg 146.90;
Riboflavin mg/kg 21.58;
Pantothenic acid mg/kg 22.81;
Pyridoxine mg/kg 10.21;
Folic acid mg/kg 0.57;
Linoleic acid (Vit F) % by weight 2.05
Vit B₁₂ mcg/kg 15.00; and
Biotin mcg/kg 1.50.
amino acids in the following amounts:
Methionine % by weight 2.80;
Lysine % by weight 3.00;
Methionine+cysteine % by weight 1.50;
Arginine % by weight 1.75;
Tryptophan % by weight 0.29;
Glycine % by weight 2.74;
Histidine % by weight 1.02;
Isoleucine % by weight 1.52;
Phenylalanine % by weight 1.32;
Phenylalanine+tyrosine % by weight 2.30;
Threonine % by weight 1.20; and
Valine % by weight 1.82.
minerals in the following amounts:
Calcium % by weight 14.60;
Phosphorous (total) % by weight 10.50;
Phosphorous (available) % by weight 10.00;
Potassium % by weight 1.77;
Sodium % by weight 4.60;
Chloride % by weight 4.45;
Magnesium % by weight 0.22;
Sulfur % by weight 0.10;
Manganese mg/kg 29.96;
Zinc mg/kg 45.94;
Iron mg/kg 300.00;
Copper mg/kg 50.53;
Cobalt mg/kg 0.11;
Iodine mg/kg 0.46; and
Selenium mg/kg 2.00.
nutrients comprising about 3.78 g/kg choline;
about 2.5 mg/kg antioxidant; and
corn distillers dried grains with or without solubles.

17. An avian broiler feed composition, comprising the pre-mix of claim 16.

18. A method of making a poultry broiler feed composition, comprising combining the pre-mix composition claim 16 with maize and soybean meal, wherein the feed composition with the combined ingredients has about 3% by weight of the broiler pre-mix composition, about 67% or about 70% maize by weight, and about 30% or 27% by weight soybean meal.

19. An avian layer feed composition, comprising the pre-mix of claim 11.

20. A method of making a poultry layer feed composition, comprising combining the pre-mix composition claim 11 with maize and soybean meal, wherein the feed composition with the combined ingredients has about 3% by weight of the layer pre-mix composition, about 58%, 59%, 63% or 67% maize by weight, and about 30% or 27% by weight soybean meal.
